(19) United States
(12) Patent Application Publication
(10) Pub. No.: US 2009/0191755 A1
(43) Pub. Date: Jul. 30, 2009

(54) Camera module connector with signal contacts retained on a shielding shell

(75) Inventors: Zhong-Jun Ma, ShenZhen (CN); Nan Hu, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/322,238

(22) Filed: Jan. 29, 2009

(30) Foreign Application Priority Data
Jan. 29, 2008 (CN) 200820031813.7

(51) Int. Cl. H01R 13/648

(52) U.S. Cl. 439/607.1

(57) ABSTRACT

A camera module connector (1) comprises a housing (10) having a plurality of sidewalls on which a plurality of conductive contacts (30) are retained and shield shell (50) attached and surrounded to an out-surface of the housing. Each conductive contact at least defines a slit hole (3011) with respect to a post (505) formed on the shield shell.

### BACKGROUND OF THE INVENTION

1. Field of the Invention

The present invention relates to an electrical connector, and more particular to an electronic module connector for interconnecting an electronic module such as a camera module for use with a cellular phone or the like to an electrical member such as a printed circuit board. The electrical connector at least includes a connector housing, a plurality of contact terminals and a shell surrounding the connector housing, wherein the contact terminals are retained on the shell.

2. Description of the Related Art

Conventionally, electronic modules such as a camera module for use with a cellular phone are securely maintained in electrical connection with an electronic member such as a printed circuit board. Therefore, an electrical connector for the camera module, formed in a shape that allows for a secured insertion of the camera module, is pre-installed on the printed circuit board. Then, the camera module is inserted into the electrical connector to electrically engage therewith. Consequently, the camera module is electrically connected with the printed circuit board via the electrical connector.

Chinese Pat No. CN 2775870 Y issued to Hui-Gao on Apr. 26, 2006 discloses an electrical connector for interconnecting a camera module with a printed circuit board comprising an insulating housing having a bottom wall and sidewalls, a plurality of signal contact retained on the sidewalls of the insulative housing, and a shielding shell surrounding the out-surface of the insulative housing. The bottom wall and sidewalls corporately defines a receiving space adapted for accommodating the camera module and each of the sidewalls defines a plurality of openings extending downwardly from an upper edge thereon. Please particular refer to FIG. 10, the every two adjacent openings are divided by a partition wall and each partition wall defines two opposite inner surfaces facing to the opening. A middle portion of each inner surface defines a recess extending downwardly from upper end and therefore there forms a weakness area at the position which the opposite recesses are located. With the increase of the contact terminals, there has a risk that the insulative housing will be break down at the position the recess is located.

Another related art shown in FIG. 5-7 discloses an similar electrical connector. It comprises an insulative housing 10′ with at least a bottom wall 100′ and a plurality of side walls 103′, a plurality of terminal contacts 30′ retained into the insulative housing 10′ and a shielding shell 50′ attaching onto an outer surface of the insulative housing 10′. Each terminal contacts 30′ includes a retaining section 301′ fixing onto the corresponding side wall 103′ of the insulative housing 10′, an elastic engaging section 305′ extending from a lower edge of the retaining section 301′ to the opposite side wall, and a tail section 303′ extending horizontally from an upper edge of the retaining section 301′. Furthermore, the retaining section 301′ defines at least a barb 3011′ adapted for retaining the terminal contact 30′ into the insulative housing 10′. Correspondingly, each side wall of the insulative housing defines a plurality of passageways 105′ extending uprightly. Please particular refer to FIGS. 6-7, every two adjacent passageways 105 define a partition (not labeled) comprising a main portion and a leg portion 1051′ disposed between the main portion and the corresponding side wall 103′, wherein the thickness of the leg portion is thinner than that of the main portion. As a result, there forms a recess (not labeled) on the leg portion 1051′ so as to retain the barb 3011′ of the terminal contact 30′.

### BRIEF SUMMARY OF THE INVENTION

It is an object of the present invention to provide a camera module connector with signal contacts retained onto a shielding shell.

In order to achieve the objective above, a shield connector in accordance with a preferred embodiment of the present invention at least comprises a housing at least having sidewalls, a plurality of terminal contacts attached to the housing, a shield shell surrounding to an out-surface of the housing, and a engaging means adapted for retaining the contacts with the shield shell.

In order to achieve the objective above, another shield connector for accommodating a camera module in accordance with a preferred embodiment of the present invention at least comprises a connector housing with an opening surrounded by side walls, a plurality of terminal contacts attached onto each side walls, a shield shell covered on an out-surface of the side wall of the connector housing, and a camera module disposed into the opening of the connector housing. Each terminal contact has an engaging hole adapted for engaging with a post formed on the shield shell.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like members in the figures and in which:

FIG. 1 is an exploded view of a camera module connector of the present invention;

FIG. 2 is a perspective view of the FIG. 1;

FIG. 3 is an another perspective view of the camera module connector of the present invention;

FIG. 4 is a cross-section view of the FIG. 11 along the line 4-4;

FIG. 5 is an exploded view of a camera module connector of a related art;

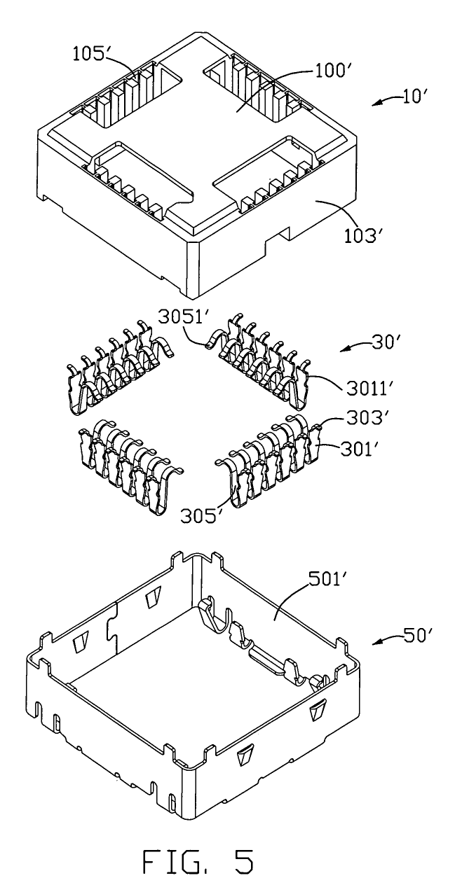

FIG. 6 is a perspective view of the camera module connector shown in FIG. 5;

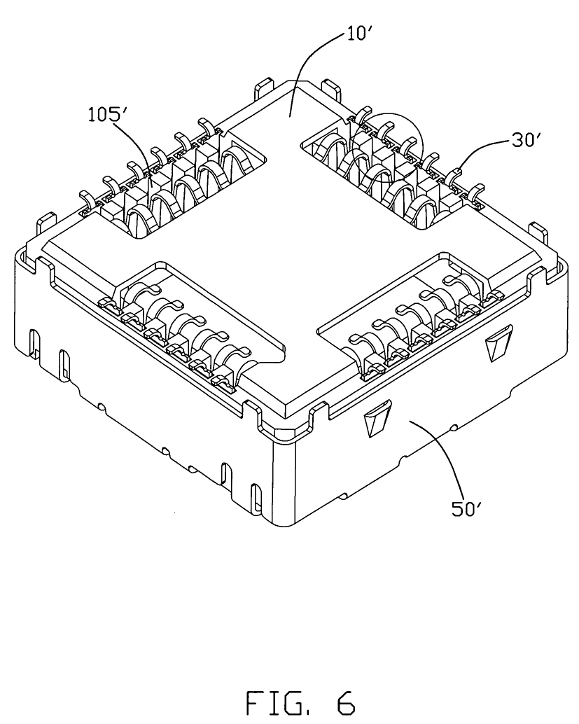

FIG. 7 is a partially enlarged view of the camera module in FIG. 6.

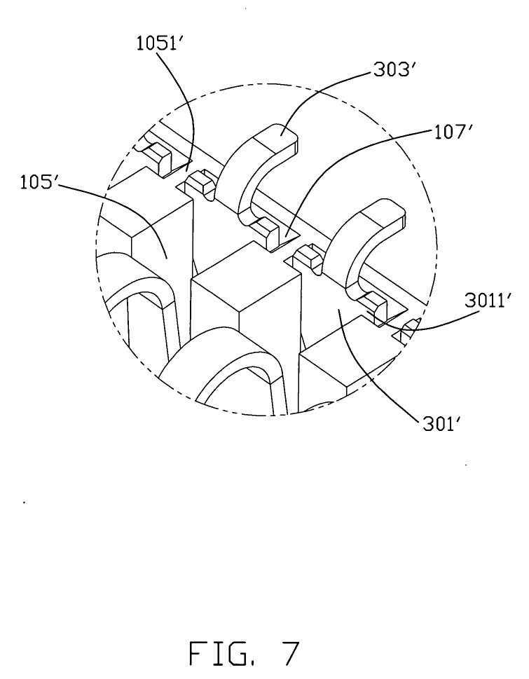

### DESCRIPTION OF PREFERRED EMBODIMENT OF THE INVENTION

In the following detailed description, for purposes of explanation, numerous specific details are set forth in order to provide a thorough understanding of the present invention. It will be apparent, however, that the present invention may be practiced without these specific details. In other instances, well-known structures and devices are schematically shown in order to simplify the drawing.

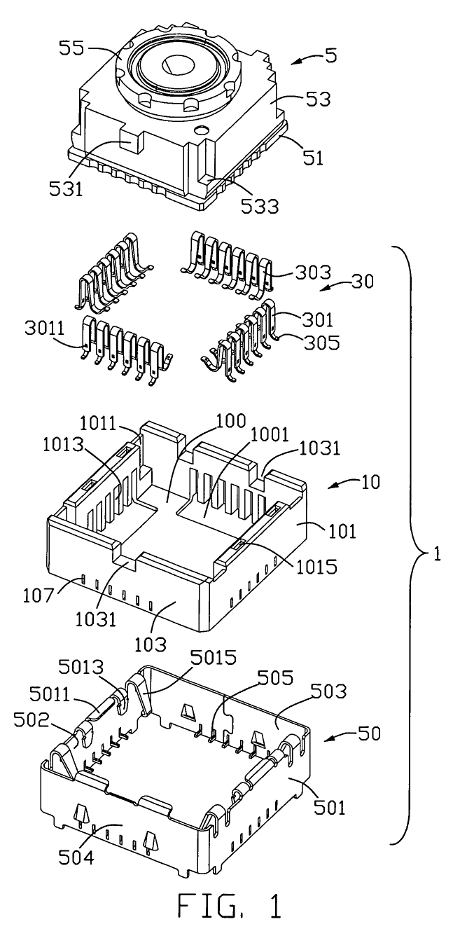

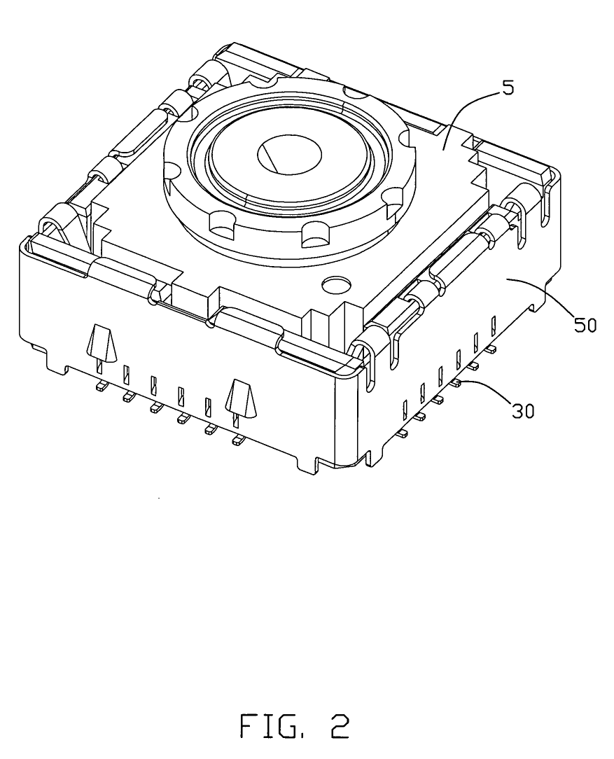

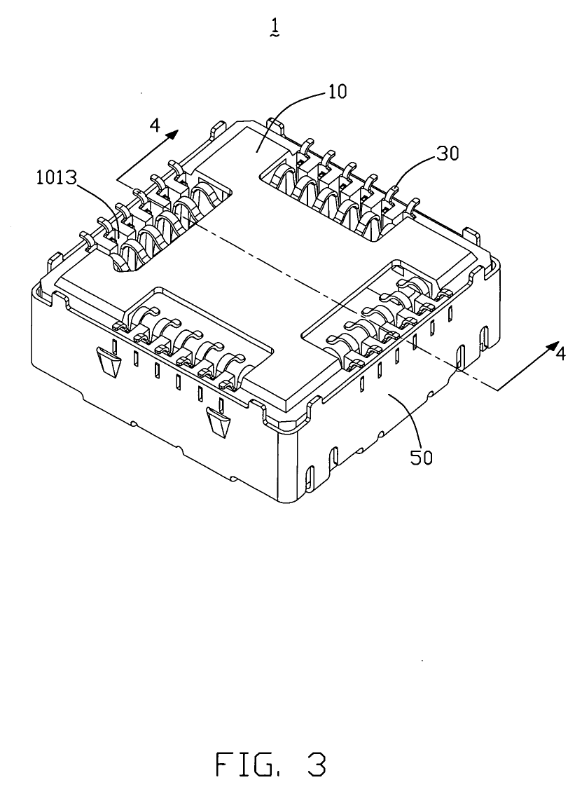

A camera module connector 1 according to the present invention is applicable to an electronic apparatus such as digital cameras, PDAs (Personal Digital Assistants), PCs (Personal Computers), mobile phones or the like. In the preferred embodiment illustrated in FIGS. 1-4, the camera module connector 1 is illustrated as to be used in a mobile handset (not shown) for connecting a camera module 5 to a PCB (not shown).

FIG. 1 is an exploded perspective view of the camera module connector 1 for receiving a camera module 5 in the embodiment of this invention. In the figures, the reference numeral 10 denotes a housing of an insulative material, such as plastic. The reference numeral 30 denotes a plurality conductive contact. The reference numeral 50 denotes a shield shell of a metal material. The reference numeral 5 denotes a camera module.

Please particular refer to FIG. 1, the camera module 5 is a variable-focus camera module that is constituted of a circuit board 51, a base 53, and a lens 55. A bottom surface of the circuit board 51 is provided with electrical pads (not labeled) and the base 53 thereof is disposed on a top surface of the circuit board 51 and the lens 55 is disposed on a top surface of the base 53. Furthermore, two opposite out-surface of the base 53 defines tabs 531 protruding from the out-surface thereof to outside, wherein there has one on one surface and two on the other surface so as to prevent misassemble. Moreover, on every corner between two adjacent side wall of the base 53 defines a recess 533 adapted for mating with a corresponding portion of the housing 10.

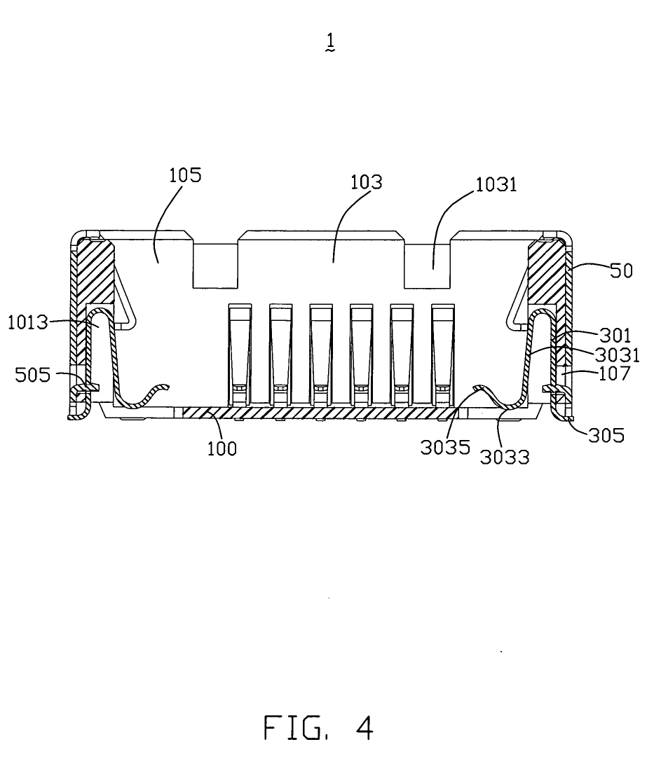

As shown in FIGS. 1-4, the housing 10 includes a bottom wall 100 and two pairs of opposite sidewalls 101, 103 connected with each other and corporately defines an accommodating space 105 (labeled in FIG. 4). Each of the sidewalls 101 and 103 defines a plurality of channel 1013 at a predetermined interval and depressed from an inner surface towards out-surface thereof and a plurality of slits 107 are formed on the out-surface thereof and penetrated with the corresponding channel 1013 so as to provide a passage by which the conductive contacts 30 attached on to the shielding shell 50.

Further, please also refer to FIGS. 1-4, a top surface of each sidewall 101 of the housing 10 defines two slots 1015 depressed downwardly at a predetermined interval and adapted to retain the shielding shell 50 onto the housing 10. Meanwhile, an end portion of each sidewall 101 defines a gap 1011 adjacent and penetrating to the accommodating space 105. Additionally, correspond to the tabs 531 of the camera module 5, the housing 10 defines an opening 1031 adapted for engaging with the tab 531. Finally, in order to increase the path of the conductive contacts 30, the bottom wall 100 further defines four rectangular slots 1001, each adjacent to the corresponding sidewalls 101 and 103.

Next, please particular refer to FIGS. 1 and 4, each of the conductive contacts 30 is formed by a metal material and includes an upright main portion 301, a tail portion 305 extending from a lower edge of the main portion 301 to outside, and an elastic engaging portion 303 extending from an upper edge of the main portion 301 and configured as a reverse U-shape with the main portion 301. A slit hole 3011 is formed on a lower position of the main portion 301 so as to engaging with the corresponding portion of the shielding shell 50. And the width of the tail portion 305 is narrower than that of the main portion 301. Additionally, the elastic engaging portion 303 includes a leg portion 3031 connected with the main portion 301 and extending downwardly from an upper edge of the main portion 301, a contact engaging portion 3035 disposed in the accommodate space 105 and adapted for contacting engaging with electrical pads formed on the bottom face of the circuit board 51 of the camera module 5, and a connecting portion 3033 between the contact engaging portion 3035 and the leg portion 3031, wherein the lowest point of the contact engaging portion 3035 is higher than that of the connecting portion 3033.

Please refer to FIG. 1, it can be noted that the main portion 301 extends uprightly and has no any barbs or a widen portion, correspondingly, each channel 1013 for receiving said main portion 301 is a rectangular shape. Therefore, there have no weakness portion in each the accommodate space 105 and when the number of the channel 1013 is increased, it is not easy to crack.

Please return to FIG. 1, the shielding shell 50 is formed of a piece of metal sheet and comprises four side plates 501, 502, 503 and 504. Two opposite side plates 501 and 502 are abut against with an out-surface of the sidewalls 101 of the housing 10 and the other opposite side plates 503 and 504 are abut against with the out-surface of the sidewalls 103 of the housing 10. An inner surface of each side plate 501, 502, 503, 504 defines a plurality of sticks or posts 505 protruding to the opposite side plate, each located on a lower position of the corresponding side plate and corresponding to the slit hole 3011 of the conductive contacts 30. When the conductive contacts 30 are assembled into the shielding shell 50, firstly, an insulative coat (not shown) is laid on an area in which the conductive contact 30 is contacting with the shell 50, then said sticks or posts 505 will get into the slit hole 3011 of the conductive contacts 30. Furthermore, the opposite side plates 501 and 502 has a same configure, each defines a pair of spring arm 5015 disposed on the corresponding gap 1011 of the housing 10 and further protruding to a center of the accommodating space 105 so as to engaging with the recess 533 of the camera module 5 and holding the camera module 5. A pair of holding leg 5013 is defined on each side plate 501 and 502 and extends from the upper edge of the corresponding side plate 501 or 502, wherein the pair of holding leg 5013 are located between the pair of spring arms 5015 and when the shielding shell 50 is attached onto the housing 10, the holding leg 5013 inserted into the corresponding slot 1015 of the housing 10. Moreover, a plurality of eaves 5011 are formed on a top face of the side plate 501, 502 and 504, when the shield shell 50 mounted onto the housing 10, said eaves 5011 will cover onto a top face of the sidewall of the housing 11.

Next, please also refer to FIGS. 1-4, in assembly, first, the conductive contacts 30 are attached on the corresponding sidewalls 101 and 103 of the housing 10 by aligning the slit hole 3011 of the conductive contacts 30 with respect to the slit 107 of the housing 10; secondly, an insulative coat is laid on the and around the stick or post 505, then the shield shell 50 surrounding and attaching to the out-surface of the housing 10, wherein the spring arms 5015 disposed on the gap 1011 of the housing 10, the holding legs 5013 inserted into the slot 1015 of the housing 10, the eaves 5011 are covered onto the top face of the sidewalls 101 and 103 of the housing 10, meanwhile, the sticks or posts 505 get into the slit hole 3011 of the conductive contact 30 via the slit 107 of the housing 10; finally, the camera module 5 is put into the accommodate space 105 from above, wherein the lens 55 is extruding to outside of the housing 10, the tabs 531 of the camera module 5 is seated onto the opening 1031 of the housing 10, the spring arms 5015 are engaging with the recess 533 of the camera module 5, and the electrical pads of the circuit board 51 is connected to the contact engaging portion 3035 of the conductive contacts 30. Therefore, a well electrical connection between the camera module 5 and the printed circuit board is provided.

In the above description of the preferred embodiment, the conductive contact defines a slit hole 3011 and the shield shell defines a stick or post with respect to the slit hole of the conductive contact. And the housing defines a slit between the slit hole of the conductive contact and the stick or post of the shield shell 50. It can be noted that through the housing has a slit, but it is only a passage for the stick passing through, not to retain the conductive contact. Therefore, when the number of the conductive contact is increase, the intension of the housing will be not reduced, as a result, it is not easy to crack.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A shield connector comprising:
a housing having a plurality of sidewalls defining an accommodating space therebetween;
a plurality of contacts attached onto the sidewalls of the housing;
a shield shell attaching to and surrounding the housing; and
an engaging means retaining the contacts with the shield shell without shorting.

2. The shield connector according to claim 1, wherein the engaging means includes a slot hole formed on each contact adapted for engaging with a holding portion formed on the shield shell.

3. The shield connector according to claim 2, wherein an inner surface of each sidewall of the housing defines a plurality of channels for receiving the corresponding portion of the contact and an out-surface of the each sidewall defines a slit penetrating with the channel by which the contact assembled onto the shield shell.

4. The shield connector according to claim 3, wherein the holding portion of the shield shell is a stick, when the shield shell and contacts are attached onto housing, the stick will get into the slit hole of the contact.

5. The shield connector according to claim 3, wherein the width of any portion of the channel is equal to each other.

6. The shield connector according to claim 1, wherein each contact at least includes a base portion extending uprightly, a tail portion extending from a lower edge of the base portion to outside of the housing, and an elastic portion extending from an upper edge of the base portion and configured as reverse U-shape with the base portion, wherein the slit hole disposed on a lower location of the base portion.

7. The shield connector according to claim 1, wherein the shield shell is formed by a piece of metal sheet and having a plurality of side plates, wherein the stick disposed on a lower position of the side plate.

8. A shield connector for receiving a camera module comprising:
a connector housing with an opening surrounded by a plurality of side walls;
a plurality terminal contacts attached onto each side walls, each having an engaging hole;
a shield shell covered on an out-surface of the side wall of the connector housing and having a post with respect to the engaging hole; and
a camera module disposed into the opening of the connector housing.

9. The shield connector according to claim 8, wherein the connector housing defines a plurality of slots, each extending from an inner face to out-face thereof, and corresponding to the engaging hole of the corresponding terminal contact.

10. The shield connector according to claim 9, wherein each terminal contact at least includes an upright portion and an elastic portion extending from an upper edge of the upright portion to a center of the opening of the connector housing, wherein the elastic portion defines a contact engaging portion at a distal end thereon adapted for engaging with electrical pads formed on bottom face of the camera module.

11. The shield connector according to claim 9, wherein the connector housing further defines a plurality of uprightly passages on each side walls, each passage penetrated bottom wall of the connector housing and intersected with the corresponding slot.

12. The shield connector according to claim 11, wherein the shield shell have a plurality of side plates corresponding to and surrounding on the side walls of the connector housing, at least one side plate defines a spring arm extending from a top edge thereof into a center of the opening and engaging with a recess formed on the camera module.

13. The shield connector according to claim 12, wherein the connector housing further defines a cutout provided on a side wall thereof to receive the spring arm.

14. The shield connector according to claim 12, wherein the shield shell further defines a holding leg extending downwardly from the top edge of a side plate and engaging with a concave formed on the top face of the connector housing.

15. The shield connector according to claim 14, wherein an eave, which is adjacent to the holding leg, is defined on the top face of the shield shell and covered onto the top face of the connector housing.

16. An electrical connector comprising:
an insulative housing defining a mating port with a side wall beside the mating port, said side wall defining, in a first transverse direction, opposite exterior and interior faces thereon;
a metallic shell covering said exterior face of the side wall in a fixed manner with regard to the housing;
a plurality of retention vertical grooves formed in said interior face of the side wall;
a plurality of contacts disposed in the housing, each of said contacts having a main body received in the corresponding groove and a contacting section extending into the mating port under condition that said groove restrains only a lateral movement of the contact relative to the housing in a second transverse direction perpendicular to said first transverse direction; wherein
said shell unitarily defines a plurality of engaging sections each extending from the exterior face to the interior face of the side wall and engaging the corresponding contact to restrain a vertical movement of the contacts relative to the housing in a vertical direction, which is perpendicular to both said first transverse direction and said second transverse direction, under condition that an insulative layer is formed between the engaging section and the corresponding contact for preventing shorting therebetween.

17. The electrical connector as claimed in claim 16, wherein said engaging section engages the corresponding contact to further restrain lateral movement of the contact relative to the housing in said first transverse direction.

18. The electrical connector as claimed in claim 16, wherein said engaging section is a post fixed into a corresponding slit hole in the corresponding contact.

19. The electrical connector as claimed in claim 16, wherein said housing defines a plurality of slits through which the corresponding engaging sections extend, respectively.
